(19) United States
(12) Patent Application Publication
(10) Pub. No.: US 2011/0219818 A1
(43) Pub. Date: Sep. 15, 2011

(54) APPARATUS AND METHOD FOR PURIFICATION OF MATERIALS USING VACUUM DISTILLATION FOR EVAPORATION AND HEAT CIRCULATION FOR CONDENSATION

(75) Inventors: Il RHEE, Seoul (KR); In-Hyoung RHEE, Asan-si (KR); Hyun-Jun JUNG, Suwon-si (KR)

(73) Assignee: SOONCHUNHYANG UNIVERSITY INDUSTRY ACADEMY COOPERATION FOUNDATION, Asan-si (KR)

(21) Appl. No.: 13/044,738

(22) Filed: Mar. 10, 2011

(30) Foreign Application Priority Data
Mar. 11, 2010 (KR) 10-2010-0021594

(51) Int. Cl. B01D 5/00

(52) U.S. Cl. 62/532; 62/124

(57) ABSTRACT

Provided is an apparatus for purifying materials, including: a raw water storage unit storing and supplying raw water; an evaporation unit evaporating the raw water supplied from the raw water storage unit; a heat exchange unit connected between the raw water storage unit and the evaporation unit, and condensing vapor (a material evaporated from the raw water) generated at the evaporation unit; and a recovery tank recovering the material condensed at the heat exchange unit, wherein the raw water supplied through the raw water storage unit is sent to the evaporation unit via the heat exchange unit, and the vapor evaporated at the evaporation unit is introduced into the recovery tank, after it is cooled and condensed at the heat exchange unit. A method for purifying materials using the apparatus is also provided. The apparatus and the method allow heat recycling, thereby reducing consumption of heat energy and electric energy, and prevent such problems as degradation of vacuum pump quality, overload or damages on some parts of the apparatus.

### CROSS-REFERENCE TO RELATED APPLICATION

This application claims priority to Korean Patent Application No. 10-2010-21594, filed on Mar. 11, 2010, and all the benefits accruing therefrom under 35 U.S.C. §119, the contents of which in its entirety are herein incorporated by reference.

### BACKGROUND

1. Field

This disclosure relates to an apparatus and a method for purifying materials using vacuum distillation for evaporation and heat circulation for condensation.

2. Description of the Related Art

In general, purification technologies using heating systems require a lot of energy to separate materials, and the materials separated thereby are condensed by a coolant (water, refrigerant gas, etc.). In the case of a vacuum heating system, since the materials are evaporated at low temperature by decreasing the pressure inside a reactor, energy consumption may be reduced. However, a large amount of coolant is required during the condensation of vapor because of increased vapor flow rate. In addition, when non-condensed vapor is introduced into a vacuum pump, several problems including overload of a pump, a drop in efficiency or damages on some parts of the system may occur. Thus, in order to prevent such problems, it is necessary to prepare a separate pump capable of exposure to vapor or to install an additional unit for removing vapor.

### SUMMARY

Disclosed herein are an apparatus and a method for purifying materials using vacuum distillation for evaporation and heat circulation for condensation.

In one aspect, there is provided an apparatus for purifying materials, including:

a raw water storage unit storing and supplying raw water;

an evaporation unit evaporating the raw water supplied from the raw water storage unit;

a heat exchange unit connected between the raw water storage unit and the evaporation unit, and condensing vapor (a material evaporated from the raw water) generated at the evaporation unit; and

a recovery tank recovering the material condensed at the heat exchange unit,

wherein the raw water supplied through the raw water storage unit is sent to the evaporation unit via the heat exchange unit, and the vapor evaporated at the evaporation unit is introduced into the recovery tank, after it is cooled and condensed at the heat exchange unit.

In another aspect, there is provided a method for purifying materials, including:

evaporating raw water to be purified under a pressure of 160 mmHg or lower; and

condensing the evaporated material by carrying out heat exchange between the evaporated material and the raw water.

The apparatus and method for purifying materials disclosed herein require no additional coolant and reduce the consumption of heat energy and electric energy through heat recycling. In addition, since no vapor is introduced into a vacuum pump, there is no need for a separate system for preventing introduction of vapor into a vacuum pump.

### BRIEF DESCRIPTION OF THE DRAWINGS

The above and other aspects, features and advantages of the disclosed exemplary embodiments will be more apparent from the following detailed description taken in conjunction with the accompanying drawing in which:

FIG. 1 is a schematic view of the apparatus for purifying materials in accordance with an embodiment of this disclosure.

### DETAILED DESCRIPTION OF MAIN ELEMENTS

| | |
|---|---|
| 1: raw water storage unit | 2: chemical metering pump |
| 3: heat exchange unit | 4: evaporation unit |
| 5: gas/liquid or gas/solid separator | |
| 6: pH and conductivity meter | 7, 8: recovery units |
| 9: air cooling unit | 10: vacuum pump |
| 11: raw water pipe | |

### DETAILED DESCRIPTION

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements. The shape, size and regions, and the like, of the drawing may be exaggerated for clarity.

In one aspect, the apparatus for purifying materials in accordance with an embodiment of this disclosure includes:

a raw water storage unit storing and supplying raw water to be purified;

an evaporation unit evaporating the raw water supplied from the raw water storage unit;

a heat exchange unit connected between the raw water storage unit and the evaporation unit, and condensing vapor (a material evaporated from the raw water) generated at the evaporation unit; and

a recovery tank recovering the material condensed at the heat exchange unit,

wherein the raw water supplied through the raw water storage unit is sent to the evaporation unit via the heat exchange unit, and the vapor evaporated at the evaporation unit is introduced into the recovery tank, after it is cooled and condensed at the heat exchange unit. In the apparatus, the raw water before the introduction into the evaporation unit and the vapor evaporated from the raw water at the evaporation unit cross with each other in the heat exchange unit. While the raw water at low temperature crosses with the hot vapor, heat exchange occurs between the two materials. As a result, the raw water may be heated before it is introduced into the evaporation unit, while the vapor may be cooled and condensed before it is introduced into the recovery tank.

According to an embodiment, the apparatus for purifying materials may further include a vacuum pump connected to the heat exchange unit. Use of such a vacuum pump may cause evaporation of raw water at a relatively low heating temperature. Evaporation conditions may vary depending on the particular type or amount of the material to be purified. For example, the evaporation temperature of raw water may be decreased to 60° C. under a pressure of 160 mmHg or lower.

According to another embodiment, the apparatus for purifying materials may further include an air cooling unit connected to the heat exchange unit. More particularly, the air cooling unit may be connected between the heat exchange unit and the vacuum pump. The gas phase material non-condensed at the heat exchange unit is condensed at the air cooling unit, and then is not sent to the vacuum pump but collected at the heat exchange unit. For example, the air cooling unit may include a fine tube having a large number of pins attached to the outside thereof, and a part supplying the external air to the pins. In this case, the gas phase material passed through the fine tube is condensed by the external air.

According to still another embodiment, the heat exchange unit may include a raw water pipe in the form of a plurality of discrete coils arranged in parallel and then joined together. The raw water supplied from the raw water storage unit is passed to the heat exchange unit along the raw water pipe, and then introduced into the evaporation unit. The raw water pipe is a closed space, and the raw water flowing along the raw water pipe serves as a refrigerant in the heat exchange unit. When the raw water pipe takes the form of a plurality of discrete coils arranged in parallel and then joined together, an additional advantage may be obtained in that the raw water pipe has an increased surface area, thereby improving heat exchange efficiency.

According to still another embodiment, the heat exchange unit may have a dual heat exchange structure capable of carrying out heat exchange/condensation by using raw water and air, and the heat exchange unit may include a raw water pipe and an air circulation space. The vapor (the material evaporated from the raw water at the evaporation unit) introduced into the heat exchange unit is not mixed with the raw water and air in the heat exchange unit but is subjected to heat exchange with the raw water and air, so that it is condensed. In addition, the air in the heat exchange unit may be cooled by the air cooling unit connected to the heat exchange unit.

According to still another embodiment, the apparatus for purifying materials may further include at least one of a gas/liquid separator and a gas/solid separator. For example, a gas/liquid separator and a gas/solid separator may be installed between the outlet of the evaporation unit and the heat exchange unit in order to prevent the impurities present in the raw water from being carried over and incorporated into the vapor. As used herein, the term “carry over” means a phenomenon in which non-volatile organic or inorganic materials fly into the atmosphere together with vapor or bubbles when a solution containing such organic or inorganic materials are boiled.

In the apparatus for purifying materials according to one embodiment disclosed herein, the evaporation unit may be formed of a material, such as stainless steel, which causes no corrosion under a general aqueous environment and has low heat conductivity toward the exterior. In addition, the heat exchange unit may be formed of a material, such as glass, copper or titanium, which causes no corrosion under an aqueous environment and has excellent heat conductivity.

According to yet another embodiment, the apparatus for purifying materials may further include at least one of a pH meter and a conductivity meter between the recovery tank and the heat exchange unit. Different kinds or amounts of materials provide different pH or conductivity values. Thus, measurement of pH and conductivity enables selective recovery of a specific material. For example, water has a pH of 7 and a conductivity of 0.1 μs/cm or less, while a basic material has a pH above 7 and an acidic material has a pH below 7. In addition, different kinds of materials have different conductivity values.

In another aspect, a method for purifying materials in accordance with an embodiment of this disclosure includes:

evaporating raw water to be purified under a pressure of 160 mmHg or lower; and

condensing vapor (a material evaporated from the raw water) by carrying out heat exchange between the vapor and the raw water. In the method, since the evaporation operation is carried out under a relatively low pressure or under vacuum, it is possible to reduce the energy supplied to perform the method significantly. In addition, since the vapor is heat exchanged with the raw water before the evaporation, energy consumption required for cooling and condensing the vapor may be reduced.

According to an embodiment, the evaporation operation and the condensation operation may be carried out at a temperature of 40-100° C. and 30° C. or lower, respectively. Different vacuum evaporation conditions may be required depending on the particular type of materials to be purified. For example, to provide desalted pure water, vacuum evaporation may be carried out at a temperature of 60-80° C. In addition, volatile amine compounds, such as ammonia, may be vaporized at a temperature of 60° C. or lower when they have a relative volatility above 1, or vaporized at a temperature of 60-80° C. when they have a relative volatility below 1, but their evaporation follows evaporation of water.

According to another embodiment, the condensation operation may further include further cooling the vapor by an air cooling unit. In this case, an additional advantage is provided in that incomplete condensation of the material evaporated from the evaporation operation is prevented and no supply of coolant is required.

According to still another embodiment, the method for purifying materials may further include, after the evaporation operation, at least one of gas/liquid separation and gas/solid separation. For example, when carrying out gas/liquid separation or gas/solid separation after the evaporation operation, it is possible to prevent the impurities present in the raw water from being carried over and incorporated into the vapor.

According to yet another embodiment, the method for purifying materials may further include measuring at least one of pH and conductivity, after the condensation operation. Different kinds or amounts of materials provide different pH or conductivity values. Thus, measurement of pH and conductivity enables selective recovery of a specific material. For example, water has a pH of 7 and a conductivity of 0.1 μs/cm or less, while a basic material has a pH above 7 and an acidic material has a pH below 7. In addition, different kinds of materials have different conductivity values.

Hereinafter, the apparatus and the method disclosed herein will be described in more detail with reference to the accompanying drawing. However, the scope of this disclosure is not limited thereto.

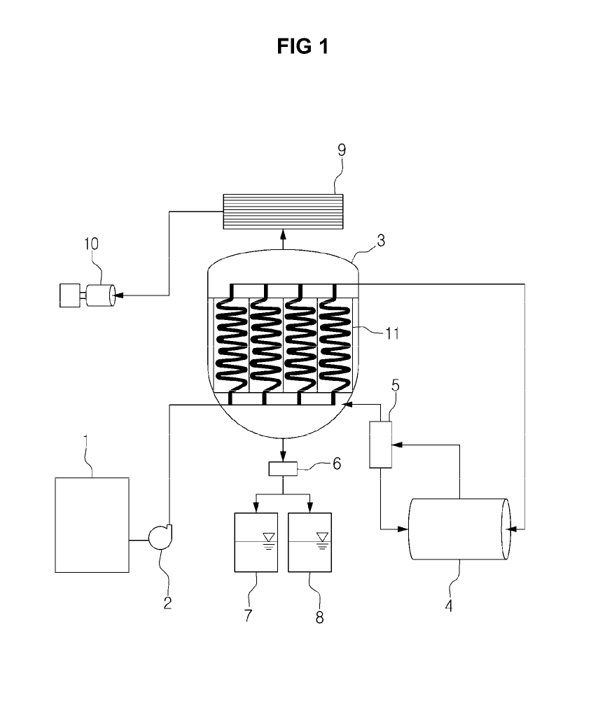

FIG. 1 is a schematic view of the apparatus for purifying materials in accordance with an embodiment of this disclosure. Referring to FIG. 1, raw water in a raw water storage unit 1 is passed to a heat exchange unit 3 through a raw water pipe 11 and then introduced to an evaporation unit 4. The raw water introduced to the evaporation unit 4 is subjected to evaporation, for example, under a pressure of 160 mmHg at a temperature of 60° C. After the evaporation, the raw water is passed through a gas/liquid separator (or a gas/solid separator) 5, where it is separated into a gas phase component and a non-evaporated component.

The gas phase component is introduced back to the heat exchange unit 3. The gas phase component introduced to the heat exchange unit 3 is in contact with the raw water pipe 11, through which the raw water supplied from the raw water storage unit 1 flows, while it is cooled and condensed. The raw water pipe 11 passing through the heat exchange unit 3 may have a plurality of discrete coils arranged in parallel and then joined together. A vacuum pump 10 is connected to the heat exchange unit 3 so that it serves to reduce the pressure applied to the raw water or to apply vacuum. An air cooling unit 9 is disposed between the heat exchange unit 3 and the vacuum pump 10, and causes any incompletely condensed gas phase component to be condensed completely.

The gas phase component of the raw water, condensed at the heat exchange unit 3, is passed through a pH and conductivity meter 6, and then is recovered at recovery units 7 and 8. The pH and conductivity meter 6 measures the pH and conductivity of a material, thereby allowing selective recovery of any desired material.

Hereinafter, the method for purifying materials using the apparatus as shown in FIG. 1 will be explained.

The method for purifying materials may include: introducing the raw water in the raw water storage unit 1 to the evaporation unit 4 through the raw water pipe 11; subjecting the raw water to vacuum evaporation under a pressure of 160 mmHg or lower at a temperature of 60° C. or higher; introducing the resultant evaporated material to the heat exchange unit 3; subjecting the evaporated material to heat exchange with the air in the heat exchange unit 3 and the raw water in the raw water pipe 11 to condense the material at a temperature of 30° C. or lower; and recovering the condensate. In addition, the raw water may be introduced to the evaporation unit 4 by a chemical metering pump 2. When recovering the condensate, the pH and conductivity meter 6, disposed between the recovery units 7 and 8 and the heat exchange unit 3, may be used to separate the condensate into its individual ingredients, which, in turn, are collected separately.

The apparatus and method for purifying materials in accordance with an embodiment of this disclosure use the raw water and air as refrigerants for heat exchange, and thus avoids a need for a separate coolant. In addition, the apparatus and method for purifying materials allow heat recycling, thereby reducing consumption of heat energy and electric energy.

According to another embodiment, the apparatus and method for purifying materials adopt a low evaporation temperature by heating the raw water at a temperature of 60° C. or higher under an internal pressure of 160 mmHg or lower, thereby reducing consumption of energy, including electric energy. Such a pressure condition of 160 mmHg or lower may be provided by the vacuum pump 10.

Further, the apparatus and method for purifying materials prevent any vapor from being introduced to the vacuum pump. Therefore, it is possible to prevent such problems as degradation of vacuum pump quality, overload or damages on some parts of the apparatus, while avoiding a need for a separate system for preventing vapor introduction into the vacuum pump.

The example will now be described. The following example is for illustrative purposes only and not intended to limit the scope of this disclosure.

### Example

The method according to an embodiment of this disclosure is used to purify raw water and to obtain desalted pure water. Use of desalted pure water avoids extra-cost required to exchange membranes periodically and to treat waste materials in various processes in the field of semiconductors, medicines, atomic force or food, thereby making such processes cost-efficient and eco-friendly.

More particularly, raw water in the raw water storage unit 1 is introduced to the evaporation unit 4 through the raw water pipe 11. The raw water is evaporated under a vacuum of 150 mmHg at a heating temperature of 60° C. to obtain only pure water as vapor. The water vapor is introduced to the heat exchange unit 3, and subjected to heat exchange with the air in the heat exchange unit 3 and the raw water in the raw water pipe 11. In this manner, the water vapor is condensed at 18° C. and the condensed water is recovered.

In addition, before the raw water is introduced to the evaporation unit, it is passed through a pretreatment filter made of polyethylene (PE) and a carbon filter packed with activated carbon in order to remove any particulate materials with a conductivity of 0.1 μs/cm and liquid organic substances. Further, the condensed water is recovered and then injected to an ion exchange resin tower to remove any trace ions.

Finally, the purified water is shown to have a conductivity of 0.06 μs/cm.

While the exemplary embodiments have been shown and described, it will be understood by those skilled in the art that various changes in form and details may be made thereto without departing from the spirit and scope of this disclosure as defined by the appended claims.

In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims.

What is claimed is:

1. An apparatus for purifying materials, comprising:
a raw water storage unit storing and supplying raw water to be purified;
an evaporation unit evaporating the raw water supplied from the raw water storage unit;
a heat exchange unit connected between the raw water storage unit and the evaporation unit, and condensing vapor (a material evaporated from the raw water) generated at the evaporation unit; and
a recovery tank recovering the material condensed at the heat exchange unit,
wherein the raw water supplied through the raw water storage unit is sent to the evaporation unit via the heat exchange unit, and the vapor evaporated at the evaporation unit is introduced into the recovery tank, after it is cooled and condensed at the heat exchange unit.

2. The apparatus for purifying materials according to claim 1, which further comprises a vacuum pump connected to the heat exchange unit.

3. The apparatus for purifying materials according to claim 2, which further comprises an air cooling unit connected between the heat exchange unit and the vacuum pump.

4. The apparatus for purifying materials according to claim 1, wherein the heat exchange unit comprises a raw water pipe having a plurality of discrete coils arranged in parallel and then joined together.

5. The apparatus for purifying materials according to claim 1, which further comprises at least one of a gas/liquid separator and a gas/solid separator.

6. The apparatus for purifying materials according to claim 1, which further comprises at least one of a pH meter and a conductivity meter, wherein the pH meter or the conductivity meter is connected to the recovery tank.

7. A method for purifying materials, comprising:
evaporating raw water to be purified under a pressure of 160 mmHg or lower; and
condensing a material evaporated from the raw water by carrying out heat exchange between the evaporated material and the raw water.

8. The method for purifying materials according to claim 7, wherein said evaporating is carried out at a temperature of 40-100° C., and said condensing is carried out at a temperature of 30° C. or lower.

9. The method for purifying materials according to claim 7, which further comprises further cooling the vapor by an air cooling unit.

10. The method for purifying materials according to claim 7, which further comprises, after said evaporating, at least one of gas/liquid separation and gas/solid separation.

11. The method for purifying materials according to claim 7, which further comprises, after said condensing, measuring at least one of pH and conductivity.
